(19) United States
(12) Patent Application Publication
(10) Pub. No.: US 2011/0006090 A1
(43) Pub. Date: Jan. 13, 2011

(54) BACKPACK

(75) Inventor: Jean-Yves BOLLARD, Veyrier du Lac (FR)

Correspondence Address: GREENBLUM & BERNSTEIN, P.L.C., 1950 ROLAND CLARKE PLACE, RESTON, VA, 20191, US

(73) Assignee: SALOMON S.A.S., Metz-Tessy (FR)

(21) Appl. No.: 12/833,464

(22) Filed: Jul. 9, 2010

(30) Foreign Application Priority Data
Jul. 10, 2009 (FR) 09.03431

(51) Int. Cl. A45F 3/14; B23P 17/04

(52) U.S. Cl. 224/257; 29/428

(57) ABSTRACT

A backpack including a front portion, a rear portion, an upper portion, and a lower portion, the backpack including a rear compartment, positioned in the rear portion and adapted to be pressed flat against the back of a user; at least one strap, the strap being fixed on the rear compartment by two distinct anchors and extending between the two anchors in the front portion of the backpack; a first loop, fixed on the lower portion of the backpack and a second loop fixed on the upper portion of the backpack. One of the loops is adjustable lengthwise, and the mechanism for adjusting the loop includes an actuating device positioned in the front portion of the backpack in order to allow for an easy adjustment of the length of the loop, even when the backpack is on the back of the user.

### CROSS-REFERENCE TO RELATED APPLICATION

This application claims priority under 35 U.S.C. §119 of French Patent Application No. 09 03431, filed on Jul. 10, 2009, the disclosure of which is hereby incorporated by reference thereto in its entirety.

### BACKGROUND

1. Field of the Invention

The present invention relates to a bag or backpack that includes an arrangement for attaching lengthy objects, such as walking sticks, ski poles, ice-axes, etc.

2. Description of Background and Other Information

An example of a bag within the aforementioned field of invention is disclosed in U.S. Pat. No. 4,518,107. More particularly, a carrier system is disclosed, which includes a pair of shoulder harness straps, a waist belt, and a rear panel adapted to be positioned against the back of the user. An upper holding strap and a lower holding strap are fixed on the upper portion and lower portion, respectively, of the carrier system. To be able to carry his skis, the user must remove the harness, open the two holding straps, insert the skis therein, close the straps again, and finally place the carrier system on his back by passing his arms into the harness straps and fastening the waist belt.

To be able to use the skis again, the user must carry out all of the preceding steps in reverse, and starting especially by removing the harness from his back.

Such a device does not facilitate a quick positioning or removal of the skis, because it is necessary to remove the shoulder harness straps and to unfasten the belt in order to be able to open and close the ski-holding straps again. The skis could be positioned/removed by another person without removing the carrier system, but not by the person wearing the carrier system.

### SUMMARY

The invention overcomes a problem arising from the prior art. In particular, the invention provides an apparatus for carrying elongated objects on the back of a user, which enables such objects to be positioned and removed without requiring the apparatus to be removed from the back of the user.

The invention also provides an apparatus, such as a backpack equipped with a carrying loop comprising an easily accessible adjustment mechanism, even when the bag is on the back of the user.

The invention also provides a particularly multipurpose backpack, in which the apparatus for carrying elongated objects can be used for other purposes when the user has no need to carry elongated objects.

To these ends, the invention is directed to a backpack that includes a front portion, a rear portion, an upper portion, and a lower portion; the backpack including a rear compartment, positioned in the rear portion and adapted to be pressed flat against the back of a user; at least one strap, this strap being fixed on the rear compartment by two distinct anchors and passing between these two anchors in the front portion of the backpack; a first loop fixed on the lower portion of the backpack and a second loop fixed on the upper portion of the backpack; one of the two loops being adjustable lengthwise and the mechanism for adjusting the loop including an actuating device that is positioned in the front portion of the bag.

According to advantageous but non-mandatory features, carrying bag, or backpack, of the invention can incorporate, in addition to the characteristics of the preceding paragraph, one or more of the following features, taken in any technically acceptable combination:

the loop(s) is/are elastic;

the first loop and second loop are not positioned on the same side of the bag, one of them being on the right side and the other on the left side;

the adjusting mechanism comprise a guiding device;

the backpack further comprises a belt, the belt being fixed on the rear compartment by two anchors and passing between these two anchors in the front portion of the backpack;

the second loop is adjustable lengthwise and the actuating device is located on the belt;

the first loop is adjustable lengthwise and the actuating device is located on the strap;

the loop and the actuating device are comprised of an elastic cord.

The invention is also directed to a method for attaching at least one elongated object, such as a pole, on a carrying bag or backpack, such method including the following: positioning a first loop, fixed on the lower portion of the backpack, and a second loop, fixed on the upper portion of the backpack, one of the two loops being adjustable lengthwise and a mechanism for adjusting the loop including an actuating device located in the front portion of the bag; verifying, then possibly adjusting the dimension of the second loop; positioning a first end of the pole in the second loop; positioning the second end of the pole in the first loop; and adjusting the length of the first loop and/or of the second loop.

### BRIEF DESCRIPTION OF THE DRAWINGS

Other characteristics and advantages of the invention will become apparent upon reading of the description that follows, with reference to the annexed drawings illustrating, by way of non-limiting examples, how the invention can be embodied, and in which:

FIG. 1 is a three-quarter left rear view of a bag, in the form of a backpack, according to the invention;

FIG. 2 is a three-quarter perspective right rear view of the bag of FIG. 1;

FIG. 3 shows a detail of the bag of FIGS. 1 and 2;

FIG. 3a is an enlarged view of a detail of FIG. 3, taken at a different angle;

FIGS. 4, 5, 6, and 7 show a series of steps for positioning a pair of poles;

FIGS. 8 and 9 show a different use of the carrying arrangement; and

FIG. 10 illustrates an alternative embodiment of the invention.

### DETAILED DESCRIPTION

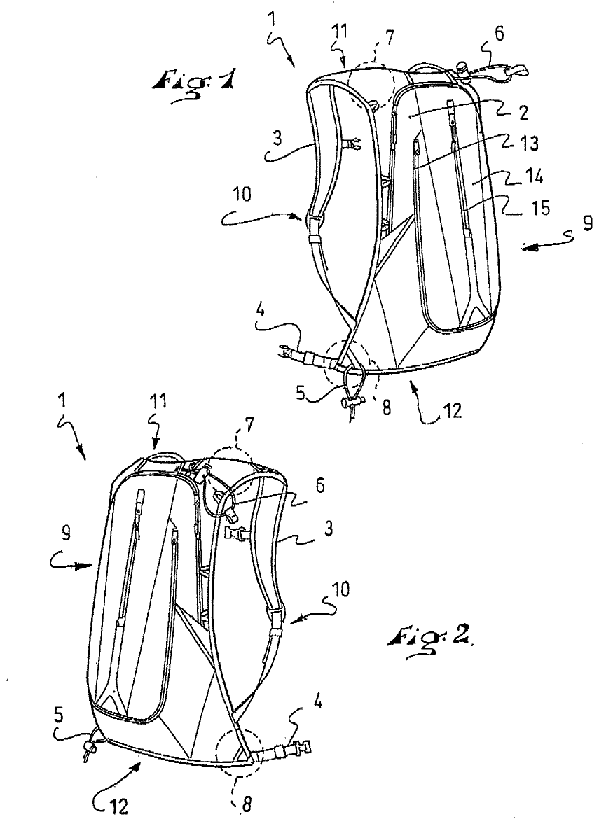

FIGS. 1 and 2 show two perspective rear views of a bag, in the form of a backpack, according to an embodiment of the invention, FIG. 1 showing a rear view from the left side, and FIG. 2 showing a rear view from the right side.

The backpack 1 includes a rear portion 9, adapted to positioned on the back of a user, a front portion 10, adapted to be positioned against the rear surface of the user's body (i.e., the chest and/or abdomen), an upper portion 11, and a lower portion 12.

The backpack further includes a rear compartment 2, adapted to receive the objects to be carried. The rear compartment 2 is closed by a peripheral zipper 13, or other type of slide fastener.

The backpack can comprise other complementary pockets 14, such as those which are positioned on the outer wall of the rear compartment 2, and which are closed by a central zipper 15, or other type of slide fastener.

The backpack is maintained on the back of the user by two straps 3, such as shoulder straps. Each strap 3 is fixed to the rear compartment by means of an upper anchor 7 positioned in the upper portion 11 of the backpack, and by means of a lower anchor 8 positioned in the lower portion 12 of the backpack.

The straps 3 constitute a portion of the front portion 10 of the backpack between the upper anchor 7 and the lower anchor 8. The front portion 10 is the only portion of the backpack that is easily accessible to the user when the backpack is in position on the user's back.

The backpack further includes a belt 4, fixed in the area of the lower portion 12 of the backpack, in the area of the two lower anchors 8. The belt constitutes another portion of the front portion 10 of the backpack between the two lower anchors 8. In a known manner, the belt includes a closure and a lengthwise adjusting mechanism.

According to the invention, the backpack includes a first loop 5, fixed on the lower portion 12 of the backpack, and a second loop 6, fixed on the upper portion 11. These two loops constitute an arrangement for attaching, on the backpack, lengthy or elongated objects that cannot easily fit in the rear compartment 2.

In a particular embodiment, the first loop 5 and second loop 6 are not positioned on the same side of the backpack. In the illustrated embodiment, the first loop 5 is located on the left side, and the second loop 6 is located on the right side. Thus, the elongated object is to be attached on the backpack along a diagonal orientation.

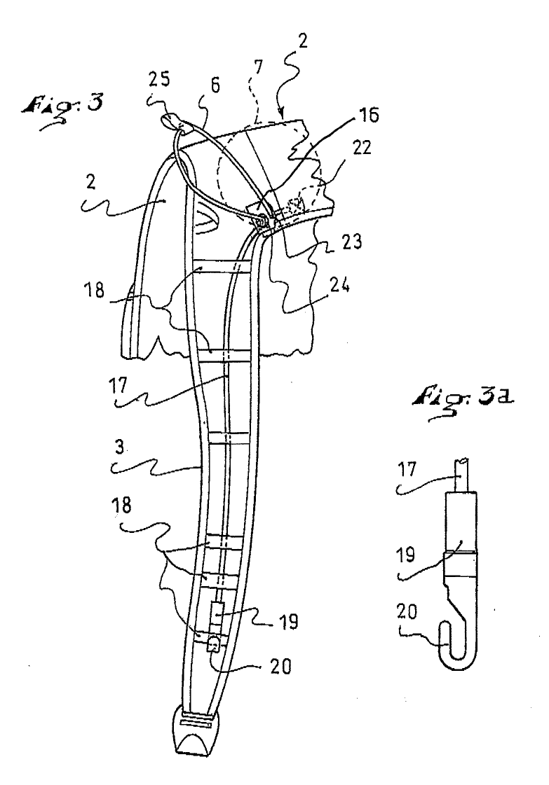

As can be seen in FIG. 3, the second loop 6 is adjustable lengthwise. FIG. 3 shows a portion of the right strap 3 and a portion of the rear compartment 2.

The arrangement for attaching long objects includes an elastic cord attached by stitching 22, or by any other known mode of fastening to the rear compartment 2. A blocker 16 is also attached on the rear compartment, in the vicinity of the fastener of the cord.

The blocker 16 is of a known type. It is comprised of a hollow cylinder in which a piston is slidably positioned. The cylinder and the piston both include transverse openings having the same cross-section, through which the cord 17 passes. The sliding motion of the piston in the cylinder is caused by a spring that biases the piston toward movement pushing the piston out of the cylinder, which results in offsetting the transverse openings of the cylinder and of the piston. The cord prevents further movement toward offsetting the side openings and thus ensures that the cord 17 is blocked in the blocker 16, as it can no longer slide through the blocker. To unblock the cord 17, it is necessary to press on the piston in order to realign the transverse openings of the piston and of the cylinder.

The blocker 16 also comprises a passage 23, arranged at the periphery of the cylinder, and through which the cord 17 passes. The inner dimensions of the passage 23 are such that the cord 17 is slightly constrained by the passage. Thus, the relative position of the blocker 16 with respect to the portion of the cord 17 that extends through the passage 23 is fixed.

The portion of the cord 17 extending between the crossing of the passage 23 and the crossing of the side openings 24 of the blocker 16 constitutes the second loop 6, whereas the portion of the cord which is beyond the blocker 16 is part of the mechanism for adjusting the length of the second loop 6.

The adjusting mechanism also includes a plurality of keepers 18 arranged on the strap to receive the cord 17, as well as an actuating device.

The actuating device is comprised of a handling grip 19 and a hook 20. For better understanding, FIG. 3a shows an enlarged view of the handling grip 19 and the hook 20 of FIG. 3 from a different angle than shown in FIG. 3.

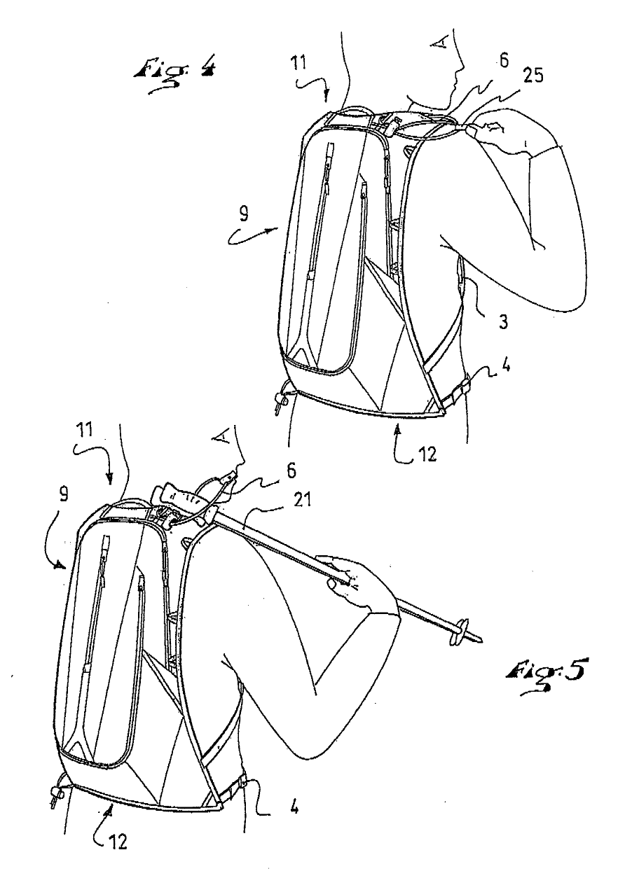

The use of the arrangement for attaching long objects according to the invention will next be described via successive steps to be undertaken by the user, and with reference to FIGS. 4 to 8.

In FIG. 4, the user locates the second loop 6, ensuring that the second loop is present in the area of the upper portion 11 of the backpack. When the backpack is on the back of the user, the upper portion 11 and lower portion 12 are more or less accessible to the user; the rear portion is not accessible at all, whereas the front portion is easily accessible. During this step, the user also checks the length of the second loop 6; the loop must be neither too large nor too small, so as to facilitate the positioning of the poles. If the loop is too large, the user can reduce its length using the actuating device. If the loop is too small, the user can release the cord by pressing on the piston of the blocker 16 and by increasing the loop by pulling thereon. To facilitate the handling of the second loop 6, a pull tab 25 is slidably mounted on the cord 17.

In FIG. 5, the user slips the handles of the ski poles 21 into the second loop 6 using his right hand. He then passes the lower portion of the poles in his left hand, from behind him. If the second loop 6 is made of an elastic material, the positioning and retention of the handles inside the second loop 6 is greatly facilitated, even if the tips of the poles are not yet retained in the first loop 5.

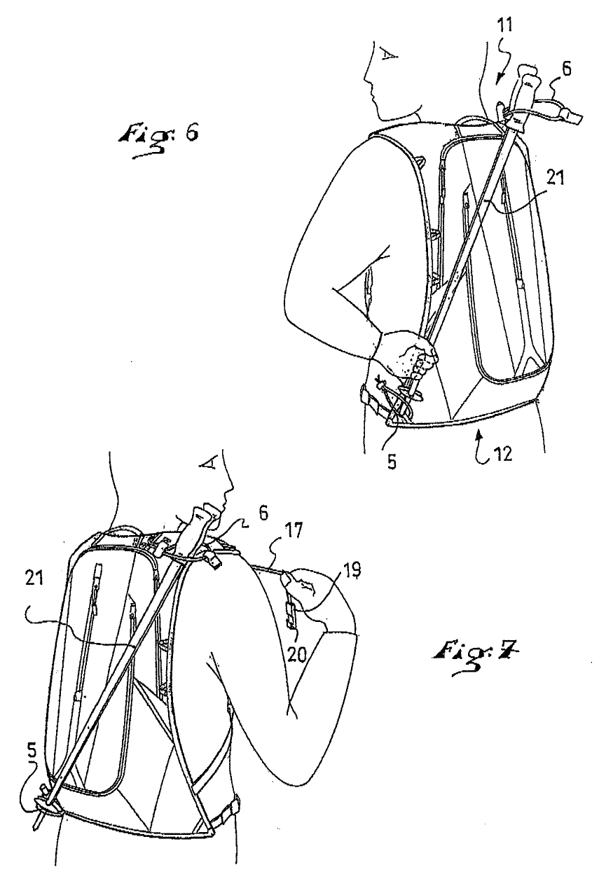

In FIG. 6, the user slips the tips of the poles 21 into the first loop 5. As with the second loop 6, the first loop 5 offers moderated access due to its position in the lower portion 12 of the backpack. Furthermore, the first loop 5 can also be equipped with a lengthwise adjusting mechanism.

In FIG. 7, the user actuates the mechanism for adjusting the second loop 6 by pulling on the cord, thereby reducing the length of the second loop 6. This last step in attaching the poles is facilitated because the actuating device is positioned on the front portion of the backpack, and in this case, on the sections of the straps that are very easily accessible to the user.

Once the desired adjustment is achieved, the hook 20 is hooked onto one of the keepers, in order to press the handling grip 19 against the strap 3.

The poles are now safely attached onto the backpack.

To use his poles again, the user performs the previously described steps in the reverse order.

The first step involves removing the hook 20 to release the actuating device. Next, the user presses on the piston of the blocker 16 in order to increase the length of the second loop 6 and to facilitate the sliding of the poles 21 within the loop.

Next, the successive steps in removing the poles correspond to those described in FIGS. 5 and 6, respectively.

In view of the arrangement of the invention for attaching elongated or lengthy objects, the user can attach and detach ski poles and walking sticks, etc., at will, without having to remove the backpack from his back. This is particularly advantageous in the context of a competition, in which the time elapsed to travel a certain distance is counted. In addition, the attaching arrangement of the invention can be used for other long objects, such as a ski, a fishing rod, etc.

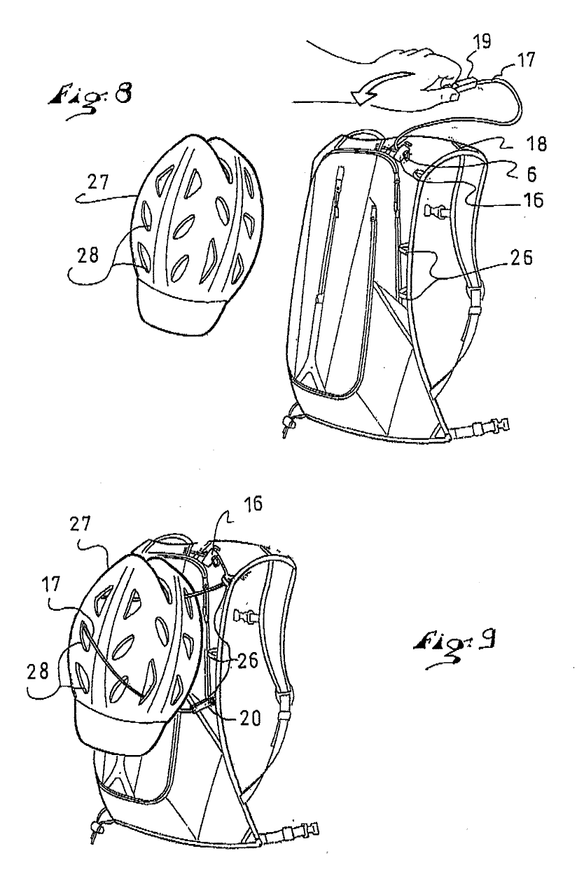

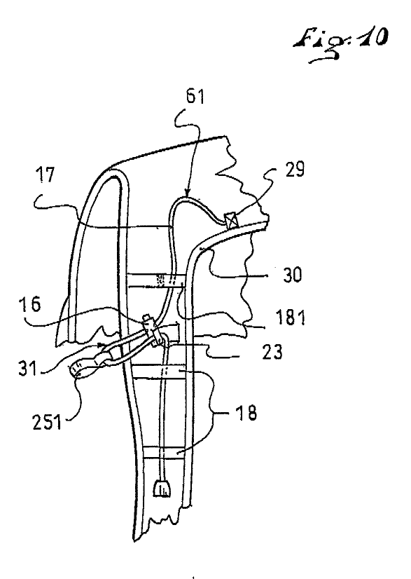

FIGS. 8 and 9 illustrate how the arrangement for carrying long objects according to the invention can also be used for other purposes. A user not wishing to increase the carrying capacity of his backpack, for example by attaching thereto objects that are too bulky to fit in the inner compartment 2, can adequately adapt the carrying arrangement.

In the illustrated example, the cord 17 is removed from the keepers 18, in which it was retained. The second loop 6 is reduced to the minimal length in order to release a maximum length of the cord 17. The cord 17 can then be used to attach a helmet 27 on the backpack by passing the cord 17 alternatively through ventilation openings 28, arranged in the helmet 27, and rings 26 that are spread on the outer surface of the rear compartment 2. The hook 20 is then hooked onto one of the rings 26.

FIG. 10 illustrates an alternative embodiment of the invention. More particularly, this view shows the upper right anchoring zone of the backpack. The elastic cord 17 is attached in the area of the stitching 29. From there, the cord 17 passes beneath an upper keeper 181. The second loop 61, structured and arranged to receive the handles of the poles, is comprised of the portion of the cord 17 that extends between the stitching 29 and the upper keeper 181, as well as the edge 30 of the strap 3.

The cord 17 continues downward from the keeper 181 until passing through the main opening of the blocker 16, i.e., the opening comprised of the two side openings of the piston and of the cylinder.

The blocker 16 also comprises a passage 23, in which the cord 17 then passes freely. The passage 23 also cooperates with a small strap sewn at its two ends on the backpack, and which is used to fix the blocker on the backpack.

Between the outlet of the main opening of the blocker and the passage, the cord defines an actuating loop 31, whose operation can be facilitated by the use of a pull tab 25. After the passage 23, the cord 17 can possibly pass through another keeper 18.

The invention is not limited to the illustrated embodiments described herein by way of examples and encompasses any and all equivalent embodiments. In particular, one can implement a pole attaching system on a carrying bolero, that is, a jacket or vest with or without sleeves which also fulfills a load-carrying function, by positioning of a rear compartment pressed against the back of the user.

The invention illustratively disclosed herein suitably may be practiced in the absence of any element which is not specifically disclosed herein.

1. A backpack adapted to be pressed flat against the back of a user, the backpack comprising:
a front portion;
a rear portion;
an upper portion;
a lower portion;
a rear compartment positioned in the rear portion (9);
at least one shoulder strap fixed on the rear compartment by two distinct anchors the strap passing between the two anchors at the front portion of the backpack;
a first loop fixed on the lower portion of the backpack;
a second loop fixed on the upper portion of the backpack;
at least one of the first and second loops including a lengthwise adjusting mechanism, said mechanism comprising an actuating device positioned at the front portion of the backpack.

2. A backpack according to claim 1, wherein:
another of the first and second loops is made of an elastic material.

3. A backpack according to claim 1, wherein:
the first loop and second loop are not located on the same side of the backpack, one of the first and second loops being located on a right side of the backpack and another of the first and second loops being located on a left side of the backpack.

4. A backpack according to claim 1, wherein:
the adjusting mechanism comprises a guiding device.

5. A backpack according to claim 1, further comprising:
a waist belt fixed on the rear compartment by means of two anchors, the waist belt extending between the two anchors at the front portion of the backpack.

6. A backpack according to claim 5, wherein:
both of the first and second loops include a respective lengthwise adjusting mechanism;
an actuating device is positioned on the belt.

7. A backpack according to claim 1, wherein:
the first loop comprises a lengthwise adjusting mechanism;
an actuating device is positioned on the shoulder strap.

8. A backpack according to claim 1, wherein:
each of the at least one of the first and second loops, as well as the actuating device, comprises an elastic cord.

9. A method for attaching at least one pole on a backpack while the backpack is worn on the back of a user, the method comprising:
positioning a first loop, fixed on the lower portion of said backpack, and a second loop, fixed on the upper portion of the backpack, to receive respective first and second portions of the pole, one of the two loops having a lengthwise adjustable mechanism, said mechanism having an actuation device positioned at a front portion of the backpack;
verifying and adjusting as necessary a dimension of the second loop;
positioning the first portion the pole within the second loop;
positioning the second portion of the pole in the first loop; and
adjusting a dimension of the first loop and/or of the second loop.
